(19) United States
(12) Patent Application Publication
(10) Pub. No.: US 2013/0297837 A1
(43) Pub. Date: Nov. 7, 2013

(54) INFORMATION TRANSFER DEVICE AND INFORMATION TRANSFER METHOD PERFORMED BY INFORMATION TRANSFER DEVICE

(71) Applicant: FUJITSU LIMITED, Kawasaki-shi (JP)

(72) Inventors: SEIJI SATTA, Fujisawa (JP); AKIRA OKAMOTO, Kawasaki (JP); YOSHIKAZU IWAMI, Inagi (JP)

(21) Appl. No.: 13/935,071

(22) Filed: Jul. 3, 2013

Related U.S. Application Data
(63) Continuation of application No. PCT/JP2011/050066, filed on Jan. 5, 2011.

(51) Int. Cl. G06F 11/30

(52) U.S. Cl. CPC G06F 11/3065
USPC 710/19

(57) ABSTRACT

An information transfer device includes a storing unit. The information transfer device includes an acquiring unit that acquires information requested by a send request or a re-send request from the storage device. The information transfer device includes a sending unit that sends the information acquired by the acquiring unit to the information processing apparatus. The information transfer device includes a retaining unit that stores the information acquired by the acquiring unit after a predetermined time period has elapsed to the storing unit. The sending unit sends the information stored in the storing unit to the information processing apparatus when the acquiring unit has not acquired the information requested by the re-send request from the storage device within the predetermined time period after the re-send request was received.

### CROSS-REFERENCE TO RELATED APPLICATIONS

This application is a continuation of International Application No. PCT/JP2011/050066, filed on Jan. 5, 2011, the entire contents of which are incorporated herein by reference.

### FIELD

The embodiments discussed herein are directed to an information transfer device and an information transfer method performed by the information transfer device.

### BACKGROUND

There is a known conventional information transfer device that, if it receives a request to send information, acquires the requested information from a storage device and then sends the acquired information. A known example of such an information transfer device is a Bus Interface (Bus IF) that acquires, if it receives a request to send information from, for example, a system controller, the requested information from a register and then transmits the acquired information to a system controller or the like.

In the following, a description will be given of a Bus IF, as an example of the Bus IF described above, that is arranged in a Large Scale Integration (LSI) that includes a register group in which information that is targeted by a send request is stored.

FIG. 15 is a schematic diagram illustrating an LSI that includes a Bus IF. An LSI 50, as illustrated in FIG. 15, includes a 3-state buffer 51, a Bus IF 52, a router 53, and a register group 54 and is connected to a system controller 60 and to CPUs 55 to 58.

If the Bus IF 52 receives a send request from the system controller 60 via the 3-state buffer 51, the Bus IF 52 requests the acquisition of the requested information from the router 53. When the router 53 is requested to acquire the information, the router 53 acquires the information requested from the register group 54 and sends the acquired information to the Bus IF 52. When the Bus IF 52 receives the information from the router 53, the Bus IF 52 sends the received information to the system controller 60.

In the Bus IF 52 described above, the period of time from when the Bus IF 52 receives a send request from the system controller 60 until when it sends the information is previously set. However, the router 53 may sometimes simultaneously receive send requests not only from the Bus IF 52 but also from the Central Processing Units (CPUs) 55 to 58. In such a case, because send requests compete with each other in the router 53, the Bus IF 52 is not able to send the requested information within a predetermined time period after the Bus IF 52 has received the send requests.

Consequently, there is a known technology that can acquire information even if competition occurs by setting a priority, which is higher than that set to the previous send request, to a retry of the send request of information that failed to be sent. In the following, the technology that can acquire information even if competition occurs will be described with reference to FIG. 16. FIG. 16 is a schematic diagram illustrating an LSI that prioritizes the processing of a retry of a send request.

In the example illustrated in FIG. 16, the LSI 50 receives a send request from the system controller 60 (Step S1) and also receives a send request from the CPU 55 (Step S2). Consequently, because the received send requests compete with each other, the LSI 50 is not able to send information to the system controller 60 within a predetermined time period. Consequently, the LSI 50 notifies the system controller 60 that the transmission of the information has failed (Step S3).

In such a case, the system controller 60 sends, to the LSI 50, a send request having a higher priority than that of the send request that was sent at Step S1 to (Step S4). At the same time at which the LSI 50 receives this re-send request from the system controller 60, the LSI 50 also receives a normal send request from the CPU 56 (Step S5).

In such a case, because a priority higher than that is given to the send request received from the CPU 56 is given to the send request received from the system controller 60, the LSI 50 executes the send request received from the system controller 60. Then, the LSI 50 sends the requested information to the system controller 60 (Step S6).
Patent Literature 1: Japanese Laid-open Patent Publication No. 2005-196808
Patent Literature 2: Japanese Laid-open Patent Publication No. 2006-343916

However, with the technology that sets, to the above described send request, a priority that is higher than that given to the previous send request, there is a problem in that, if an LSI receives a send request whose priority is higher than that of a send request that was resent, there is a loss due to priority competition again, and thus the transmission of the information fails.

FIG. 17 is a schematic diagram illustrating a state in which transmission of information has failed again. As illustrated in FIG. 17, the LSI 50 acquires a request to transfer information from each of the system controller 60 and the CPU 55 (Steps S7 and S8). Because the transfer requests compete with each other, the LSI 50 is not able to send the information to the system controller 60 within a predetermined time period; therefore, the LSI 50 notifies the system controller 60 that the transmission of the information has failed (Step S9).

Consequently, the system controller 60 sends, to the LSI 50, a send request having a higher priority than that of the previous send request (Step S10). However, if the LSI 50 receives, from the CPU 56, a send request having a higher priority than that of the send request received from the system controller 60 (Step S11), there is a loss due to priority competition again. Consequently, the LSI 50 is not able to send the information to the system controller 60 within a predetermined time period, and thus the LSI 50 notifies the system controller 60 again that the transmission of the information has failed (Step S12).

Furthermore, if priority control of the LSI is simple, the system controller 60 and the CPUs 55 to 58 continue to increase the priority of their send requests each time they resend them. Consequently, losses due to priority competition of the send requests continue, and thus there is possibility of live lock occurring. Furthermore, if the number of ports that acquire a send request of information is large, the circuit for determining the priorities of the acquired requests becomes complicated and thus the size of the circuit becomes large.

The present invention has been conceived, in light of the circumstances described above, such that a response to a retry of a send request is reliably made.

It is an object in one aspect of an embodiment of the present invention to provide an information transfer device that includes a storing unit that temporarily stores therein, if information targeted by a send request is not able to be acquired within a predetermined time period after the send request for the information is received, information targeted by a send request that is subsequently acquired. Furthermore, if the information transfer device receives a retry of a send request with respect to the information that has failed to be sent and if the information transfer device has failed to acquire the information targeted by the send request again before a predetermined time period has elapsed, the information transfer device sends the information stored in the storing unit.

### SUMMARY

According to an aspect of an embodiment, an information transfer device includes a storing unit that temporarily stores therein information to be sent. The information transfer device includes an acquiring unit that acquires, when a send request of information stored in a storage device is received from an information processing apparatus, information requested by the send request from the storage device even after a predetermined time period after the send request was received had elapsed. The information transfer device includes a sending unit that sends, when the acquiring unit has acquired the information requested by the send request from the storage device within the predetermined time period after the send request was received, the information acquired by the acquiring unit to the information processing apparatus and that sends, when the acquiring unit has not acquired the information requested by the send request from the storage device within the predetermined time period after the send request was received, a notification indicating that acquiring information was failed to the information processing apparatus. The information transfer device includes a retaining unit that stores the information acquired by the acquiring unit after the predetermined time period has elapsed to the storing unit. The acquiring unit acquires, when the acquiring unit receives from the information processing apparatus a re-send request that is a retry of the send request for the information requested by the send request, the information requested by the re-send request from the storage device. The sending unit sends, when the acquiring unit acquired the information requested by the re-send request from the storage device within the predetermined time period after the re-send request was received, the information acquired by the acquiring unit to the information processing apparatus and sends, when the acquiring unit has not acquired the information requested by the re-send request from the storage device within the predetermined time period after the re-send request was received, the information stored in the storing unit to the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an LSI according to a first embodiment;

FIG. 2 is a schematic diagram illustrating each unit included in the LSI according to the first embodiment;

FIG. 3 is a schematic diagram illustrating an example of a request management unit 11 according to the first embodiment;

FIG. 4 is a schematic diagram illustrating a time-out of a read request;

FIG. 5 is a schematic diagram illustrating a process for transmitting data performed by a Bus IF that includes a single buffer;

FIG. 6 is a schematic diagram illustrating the flow of a process performed by the LSI for transmitting data in response to a read request;

FIG. 7 is a schematic diagram illustrating the flow of a process performed by the LSI for transmitting data in response to a retry;

FIG. 8 is a schematic diagram comparing a conventional LSI with the LSI according to the first embodiment;

FIG. 9 is a schematic diagram illustrating the utilization rate of a bus;

FIG. 10 is a schematic diagram illustrating a router that processes a read request to which a priority has been given;

FIG. 11 is a schematic diagram illustrating a router according to the first embodiment;

FIGS. 12A and 12B are flowcharts illustrating the flow of a process performed by an LSI 1;

FIGS. 13A and 13B are flowcharts illustrating the flow of a process performed when data transmission has failed;

FIGS. 14A and 14B are flowcharts illustrating the flow of a process performed when a retry is performed;

FIG. 15 is a schematic diagram illustrating an LSI that includes a Bus IF;

FIG. 16 is a schematic diagram illustrating an LSI that prioritizes the processing of a retry of a send request; and

FIG. 17 is a schematic diagram illustrating a state in which transmission of information has failed again.

### DESCRIPTION OF EMBODIMENTS

Preferred embodiments of the present invention will be explained with reference to accompanying drawings.

### [a] First Embodiment

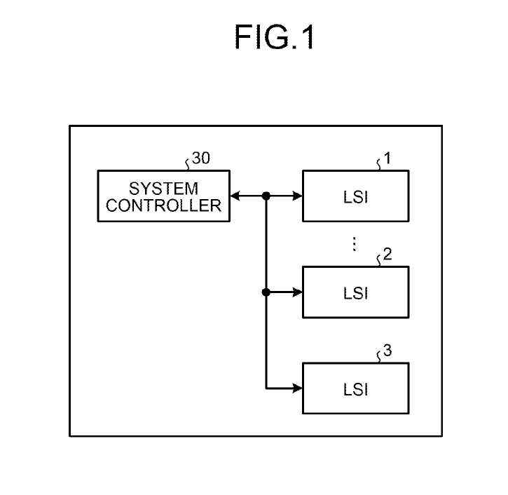

FIG. 1 is a schematic diagram illustrating an LSI according to the first embodiment. As illustrated in FIG. 1, multiple LSIs 1 to 3 are connected to a system controller 30 by a system bus. The LSIs 2 and 3 are LSIs having the same configuration as that of the LSI 1. Furthermore, as will be described below, each of the LSIs 1 to 3 includes a register group in which information is stored.

The system controller 30 is connected to each of the LSIs 1 to 3 by the bidirectional system bus and sends, to each of the LSIs 1 to 3, a read request with respect to the information stored in a register in each of the LSIs 1 to 3. Then, the system controller 30 receives a response to the read request from each of the LSIs 1 to 3.

At this point, as described later, if a given LSI, from the LSIs 1 to 3, is not able to send to the system controller 30, information targeted by the read request within a predetermined time period after the given LSI has received the read request from the system controller 30, then the given LSI sends a notification that transmission has failed. In such a case, the system controller 30 sends a retry of the read request with respect to the data failed to be sent.

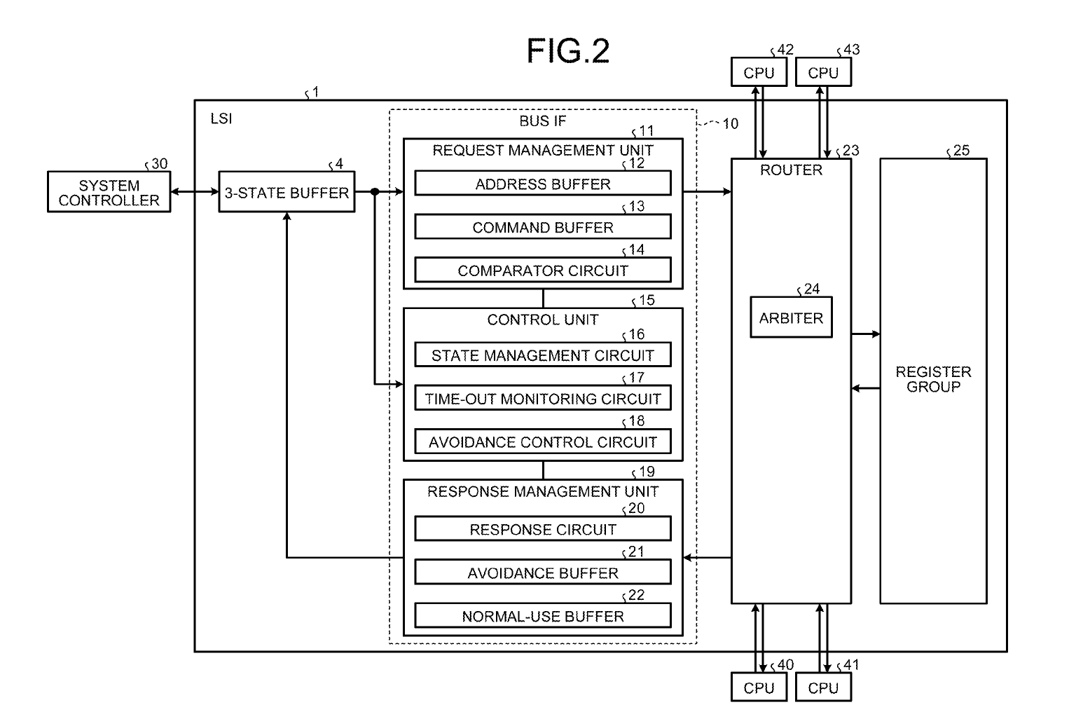

The LSI 1 includes a register that stores therein information and executes a process on the read request received from the system controller 30. In the following, the LSI 1 will be described in detail with reference to FIG. 2.

FIG. 2 is a schematic diagram illustrating each unit included in the LSI according to the first embodiment. In the example illustrated in FIG. 2, the LSI 1 includes a 3-state buffer 4, a Bus IF 10, a router 23, and a register group 25. The Bus IF 10 includes a request management unit 11, a control unit 15, and a response management unit 19.

The request management unit 11 includes an address buffer 12, a command buffer 13, and a comparator circuit 14. The control unit 15 includes a state management circuit 16, a time-out monitoring circuit 17, and an avoidance control circuit 18. The response management unit 19 includes a response circuit 20, an avoidance buffer 21, and a normal-use buffer 22.

The router 23 includes an arbiter 24; is connected to CPUs 40 to 43; and receives, from each of the CPUs 40 to 43, a read request with respect to information stored in the register group 25. The register group 25 is a storage device in which data targeted by the read request is stored.

In the following, each of the units 4 to 25 included in the LSI 1 will be described. If the 3-state buffer 4 receives a read request for information from the system controller 30, the 3-state buffer 4 sends the received read request to the request management unit 11 and the control unit 15. Furthermore, if the 3-state buffer 4 receives data from the response management unit 19, which will be described later, the 3-state buffer 4 sends the received data to the system controller 30.

The Bus IF 10 is an information transfer device. If the Bus IF 10 receives a read request from the system controller 30, the Bus IF 10 acquires, from the register group 25, data targeted by the read request and sends the acquired data to the system controller 30. In the following, each of the units included in the Bus IF 10 will be described.

If the request management unit 11 receives, from the system controller 30, a read request with respect to the data that is stored in the register group 25, the request management unit 11 issues, to the register group 25, a request from which data targeted by a read request is requested.

Specifically, the request management unit 11 receives, from the 3-state buffer 4, as the read request, a memory address, which is an address of a register allocated to a memory in the register group 25 and is targeted by the read request, and a read command indicating that the data is to be read. In such a case, the request management unit 11 stores the received memory address in the address buffer 12 and stores the received read command in the command buffer 13.

If the request management unit 11 receives, from the state management circuit 16, which will be described later, an enable signal that indicates the time at which the read request is sent to the router 23, the request management unit 11 sends, to the router 23, the memory address and the command stored in the address buffer 12 and the command buffer 13.

Furthermore, if the request management unit 11 receives a new read request by using the comparator circuit 14, which will be described later, the request management unit 11 determines whether the memory address that is targeted, for a process, by the previously received read request matches the memory address that is targeted, for a process, by the new read request. If the request management unit 11 determines that the memory address that is targeted, for a process, by the previously received read request matches the memory address that is targeted by the new read request, the request management unit 11 sends, to the avoidance control circuit 18, a signal indicating that a retry of a send request with respect to the data whose acquisition has failed.

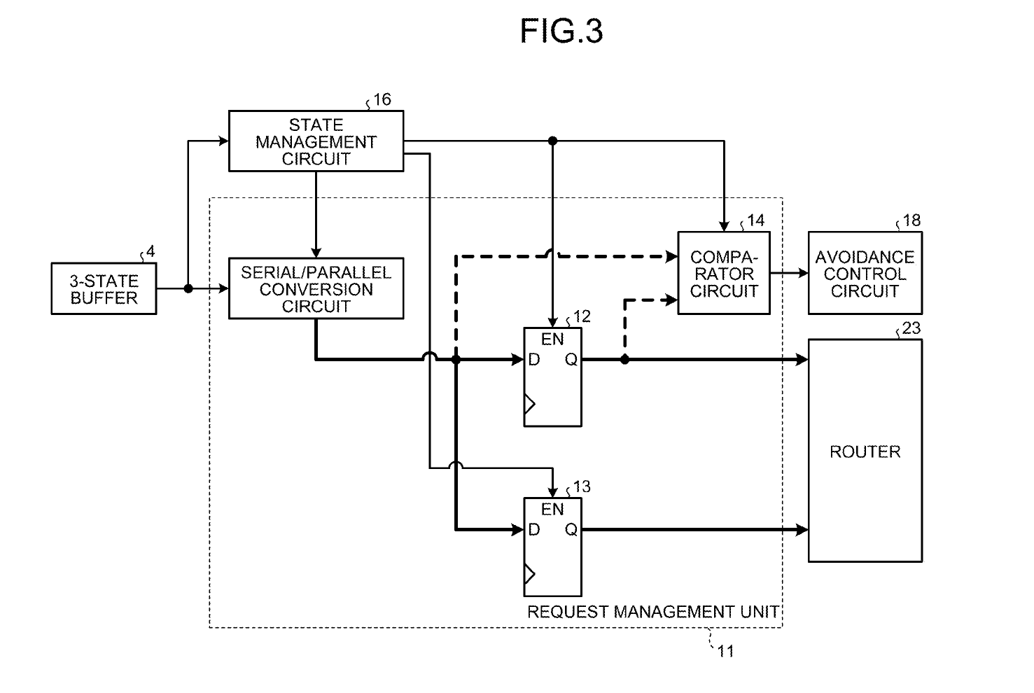

In the following, an example of the request management unit 11 will be described with reference to FIG. 3. FIG. 3 is a schematic diagram illustrating an example of the request management unit 11 according to the first embodiment. In the example illustrated in FIG. 3, the request management unit 11 includes a serial/parallel conversion circuit, the address buffer 12, which is an enable D type flip-flop, and the command buffer 13, which is an enable D type flip-flop. In the description below, it is assumed that the 3-state buffer 4 receives a 1-bit serial signal from the system controller 30 via a bus.

For example, if the serial/parallel conversion circuit receives a serial signal containing a read request from the 3-state buffer 4, the serial/parallel conversion circuit converts the received 1-bit serial signal to an 8-bit parallel signal. If the serial/parallel conversion circuit receives a shift enable signal from the state management circuit 16, the serial/parallel conversion circuit sends the converted signal to the comparator circuit 14 in addition to the address buffer 12 and the command buffer 13.

The address buffer 12 and the command buffer 13 retain therein the parallel signal output from the serial/parallel conversion circuit triggered when a capture enable signal is output from the state management circuit 16. Then, the address buffer 12 and the command buffer 13 pass the retained parallel signal through a decoder (not illustrated). The decoder decodes a memory address and a command received from the parallel signal and sends the decoded memory address and the command to the router 23.

Only when the comparator circuit 14 receives an enable signal from the state management circuit 16, does the comparator circuit 14 compare the signal received from the serial/parallel conversion circuit with the signal received from the address buffer 12 and determines whether the memory addresses indicated by the signals match. Specifically, the comparator circuit 14 determines whether the memory address that is to be processed by the read signal received this time matches the memory address that is to be processed by the read signal previously received.

If the comparator circuit 14 determines that memory addresses indicated by the signals match, the comparator circuit 14 sends, to the avoidance control circuit 18, a signal indicating “0”, which is used as a difference detection signal and indicates that the memory addresses indicated by the signals match. In contrast, if the comparator circuit 14 determines that the memory addresses indicated by the signals do not match, the comparator circuit 14 sends, to the avoidance control circuit 18, a signal indicating “1”, which is used as a difference detection signal and indicates that the memory addresses indicated by the signals do not match.

Referring back to FIG. 2, a description will be given of a process performed by the state management circuit 16, the time-out monitoring circuit 17, and the avoidance control circuit 18 included in the control unit 15. If the state management circuit 16 receives data from the 3-state buffer 4 and becomes in a state in which a request is analyzed, the state management circuit 16 sends a shift enable signal to the serial/parallel conversion circuit in the request management unit 11 and sends a capture enable signal to the address buffer 12, the command buffer 13, and the comparator circuit 14.

If the time-out monitoring circuit 17 receives a notification from the 3-state buffer 4 indicating that a read request has been received, the time-out monitoring circuit 17 counts the elapsed time since the read request was received and determines whether a predetermined time has elapsed since the read request was received. If the time-out monitoring circuit 17 determines that a predetermined time has elapsed since the read request was received, the time-out monitoring circuit 17 notifies the avoidance control circuit 18 that the predetermined time has elapsed.

The avoidance control circuit 18 controls each of the units 20 to 22 included in the response management unit 19 and sends a response to the read request to the system controller 30. Specifically, the avoidance control circuit 18 executes a process that stores the data acquired from the register group 25 in the avoidance buffer 21 and the normal-use buffer 22 and executes a process that sends the data stored in the avoidance buffer 21 or the normal-use buffer 22 to the system controller 30.

In the following, out of the processes executed by the avoidance control circuit 18, the flow of the process that stores the data acquired from the register group 25 in the avoidance buffer 21 and the normal-use buffer 22 will be described in detail. First, the avoidance control circuit 18 receives a difference detection signal from the comparator circuit 14.

If the difference detection signal determined by the comparator circuit 14 to be “1” is received, i.e., if a read request is received indicating that a memory address different from that indicated by the previous read request is to be processed, the avoidance control circuit 18 resets both a lock flag included in the avoidance buffer 21, which will be described later, and a transmission available flag included in the normal-use buffer 22, which will be described later, to “0”.

Furthermore, if no difference is detected, the avoidance control circuit 18 continues the process described below without processing anything.

Then, if the response management unit 19 receives data to be read, the avoidance control circuit 18 determines whether the avoidance buffer 21 is empty. Specifically, the avoidance control circuit 18 determines whether the lock flag included in the avoidance buffer 21 is “1”. If it is determined that the lock flag is “0”, the avoidance control circuit 18 determines that the avoidance buffer 21 is empty.

If it is determined that the avoidance buffer 21 is empty, the avoidance control circuit 18 stores the received data in the avoidance buffer 21 and the normal-use buffer 22. Furthermore, if the avoidance control circuit 18 stores the data in the normal-use buffer 22, the avoidance control circuit 18 sets the transmission available flag to “1”. Furthermore, the avoidance control circuit 18 sets the lock flag included in the avoidance buffer 21, which will be described later, to “1”.

Furthermore, if the avoidance control circuit 18 determines that the avoidance buffer 21 is not empty, the avoidance control circuit 18 stores the received data only in the normal-use buffer 22 and sets the transmission available flag in the normal-use buffer 22 to “1”.

Specifically, if the avoidance control circuit 18 determines that the avoidance buffer 21 is empty, the avoidance control circuit 18 stores the data received by the response management unit 19 in both the avoidance buffer 21 and the normal-use buffer 22. Furthermore, if data is stored in the avoidance buffer 21 and if the lock flag is “1”, the avoidance control circuit 18 stores the data received by the response management unit 19 only in the normal-use buffer 22.

Furthermore, the avoidance control circuit 18 executes a process that stores the data described above regardless of whether it receives a notification from the time-out monitoring circuit 17 indicating that a predetermined time period has elapsed. Specifically, even if a predetermined time period has elapsed since a read request was received, if the response management unit 19 acquires data from the register group 25, the avoidance control circuit 18 also stores the acquired data in the avoidance buffer 21 and sets the lock flag stored in the avoidance buffer 21 to “1”.

In the following, out of the processes executed by the avoidance control circuit 18, the process that sends the data stored in the avoidance buffer 21 or the normal-use buffer 22 to the system controller 30 will be described. Specifically, if the avoidance control circuit 18 receives a notification from the time-out monitoring circuit 17 indicating that a predetermined time period has elapsed, the avoidance control circuit 18 starts the process that sends the data to the system controller 30.

First, if the avoidance control circuit 18 receives a notification from the time-out monitoring circuit 17 indicating that a predetermined time period has elapsed, the avoidance control circuit 18 determines whether the transmission available flag in the normal-use buffer 22 is “1”. If it is determined that the transmission available flag in the normal-use buffer 22 is “1”, the avoidance control circuit 18 sends the data stored in the normal-use buffer 22 to the system controller 30. Furthermore, if the avoidance control circuit 18 sends the data stored in the normal-use buffer 22 to the system controller 30, the avoidance control circuit 18 resets the lock flag stored in the avoidance buffer 21 and the transmission available flag stored in the normal-use buffer 22 to “0”.

In contrast, if it is determined that the transmission available flag in the normal-use buffer 22 is “0”, the avoidance control circuit 18 determines whether the lock flag in the avoidance buffer 21 is “1”. If it is determined that the transmission available flag in the normal-use buffer 22 is “0”, the avoidance control circuit 18 controls the response circuit 20 and then notifies the system controller 30 that reading of data has failed.

In contrast, if it is determined that the lock flag in the avoidance buffer 21 is “1”, the avoidance control circuit 18 controls the response circuit 20 and then sends the data stored in the avoidance buffer 21 to the system controller 30. Specifically, if the transmission available flag in the normal-use buffer 22 is “0” and the lock flag in the avoidance buffer 21 is “1”, the avoidance control circuit 18 sends the data stored in the avoidance buffer 21 to the system controller 30. Furthermore, if the avoidance control circuit 18 sends the data stored in the avoidance buffer 21 to the system controller 30, the avoidance control circuit 18 sets the lock flag stored in the avoidance buffer 21 to “0”.

Specifically, if the response management unit 19 receives the data that is targeted by a read request before it receives a notification from the time-out monitoring circuit 17 indicating that a predetermined time period has elapsed, the avoidance control circuit 18 sends the data stored in the normal-use buffer 22 to the system controller 30. Furthermore, if the response management unit 19 does not receive the data that is targeted by a read request before it receives a notification from the time-out monitoring circuit 17 indicating that a predetermined time period has elapsed, the avoidance control circuit 18 sends a notification to the system controller 30 indicating that reading of the data has failed.

Furthermore, as described above, if the response management unit 19 receives the data that is targeted by a read request after it has received a notification from the time-out monitoring circuit 17 indicating that a predetermined time period had elapsed, the avoidance control circuit 18 stores the received data in the avoidance buffer 21. Consequently, if a retry with respect to the failed read request is received from the system controller 30, the data acquired when the immediately previous read request was received has already been stored in the avoidance buffer 21.

If the response management unit 19 does not receive the data targeted by the retry before a notification indicating that a predetermined time period has elapsed is received from the time-out monitoring circuit 17, the avoidance control circuit 18 sends the data stored in the avoidance buffer 21 to the system controller 30. Furthermore, if the response management unit 19 receives the data targeted by the retry before a notification indicating that a predetermined time period has elapsed is received from the time-out monitoring circuit 17, the avoidance control circuit 18 sends the data stored in the normal-use buffer 22 to the system controller 30. Consequently, if the Bus IF 10 receives, from the system controller 30, a retry with respect to the failed read request, the Bus IF 10 can reliably send back a response.

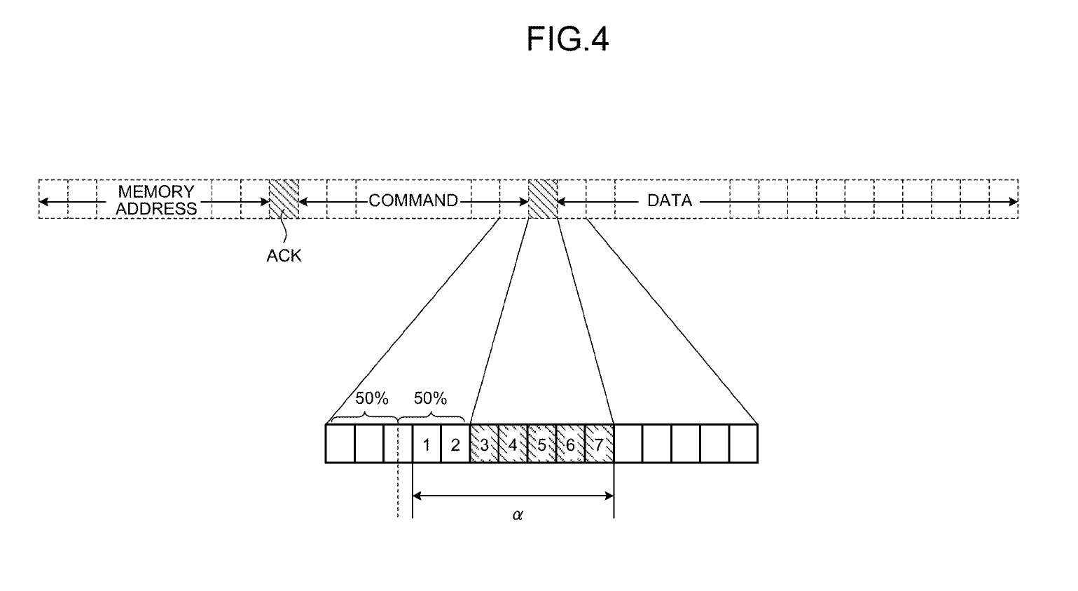

In the following, a time-out performed on a read request will be described with reference to FIG. 4. FIG. 4 is a schematic diagram illustrating a time-out of a read request. In the description below, it is assumed that the system controller 30 is connected to the LSI 1 by a low speed system bus, such as an Inter-Integrated Circuit/System Management Bus (12C/SMBus: registered trademark).

Furthermore, the blocks represented by the dotted line illustrated in FIG. 4 indicate data in per clock pulse (external clock) in a bus. Furthermore, the blocks represented by the solid line illustrated in FIG. 4 indicate data in units of clock inside the LSI 1. Specifically, the example in FIG. 4 illustrates that the LSI 1 operates at a clock frequency that is five times that of the bus clock.

In such a case, the LSI 1 and the system controller 30 send and receive read requests and data targeted by the read requests in the following order: memory address, ACK, command, ACK, and data. Accordingly, in the example illustrated in FIG. 4, if data is captured at the center of the bus clock, the LSI 1 needs to be in a state, as indicated by a in FIG. 4, in which the LSI 1 can send data within the time period corresponding to seven clock pulses in the LSI 1 after the LSI 1 has received a command.

Accordingly, if the Bus IF 10 is not able to acquire data stored in the register group 25 before a predetermined time period has elapsed after the Bus IF 10 received the read request, the Bus IF 10 recognizes that the read request has timed out and notifies the system controller 30 that the data transmission has failed. A method in accordance with the specification of a bus, such as a cyclic redundancy check (CRC), an ACK, or status bits, can be used as the method by which the Bus IF 10 notifies that a reading has failed.

Referring back to FIG. 2, the response management unit 19 includes the avoidance buffer 21 and the normal-use buffer 22, which temporarily store data sent to the system controller 30. If the response management unit 19 acquires data from the register group 25 within a predetermined time period after the read request was received, the response management unit 19 stores the acquired data in the normal-use buffer 22. Then, the response management unit 19 sends the data stored in the normal-use buffer 22 to the system controller 30.

In contrast, if the response management unit 19 does not receive data from the register group 25 before a predetermined time period has elapsed since the read request was received, the response management unit 19 notifies the system controller 30 via the 3-state buffer 4 that the reading has failed. Furthermore, if the response management unit 19 receives data from the register group 25 after a predetermined time period has elapsed since the read request was received, the response management unit 19 stores the received data in the avoidance buffer 21. Furthermore, if the response management unit 19 is not able to acquire the data stored in the register group 25 again within a predetermined time period after a retry is received, the response management unit 19 sends the data stored in the avoidance buffer 21 to the system controller 30.

In the following, each of the units included in the response management unit 19 will be described. The response circuit 20 is controlled by the avoidance control circuit 18. If the response circuit 20 receives data from the register group 25 after a predetermined time period has elapsed since the read request was received, the response circuit 20 sends the data stored in the normal-use buffer 22 to the system controller 30.

In contrast, if the response circuit 20 does not receive data from the register group 25 within a predetermined time period after the read request was received, the response circuit 20 notifies the system controller 30 indicating that the reading has failed. Furthermore, the response circuit 20 stores the data received from the register group 25 thereafter in the avoidance buffer 21. If the response circuit 20 does not receive data from the register group 25 within a predetermined time period after the retry was received, the response circuit 20 sends the data stored in the avoidance buffer 21 in the system controller 30.

The avoidance buffer 21 and the normal-use buffer 22 are a buffer that temporarily store read data that is sent to the system controller 30. Furthermore, the avoidance buffer 21 includes a lock flag. If the lock flag is “1”, this indicates that data is stored in the avoidance buffer 21. If the lock flag is “0”, this indicates that data is not stored in the avoidance buffer 21. Furthermore, if the transmission available flag is set in the normal-use buffer 22 and if the transmission available flag is “1”, this indicates that the data stored in the normal-use buffer 22 can be sent. If the transmission available flag is “0”, this indicates that the data stored in the normal-use buffer 22 is not able to be sent.

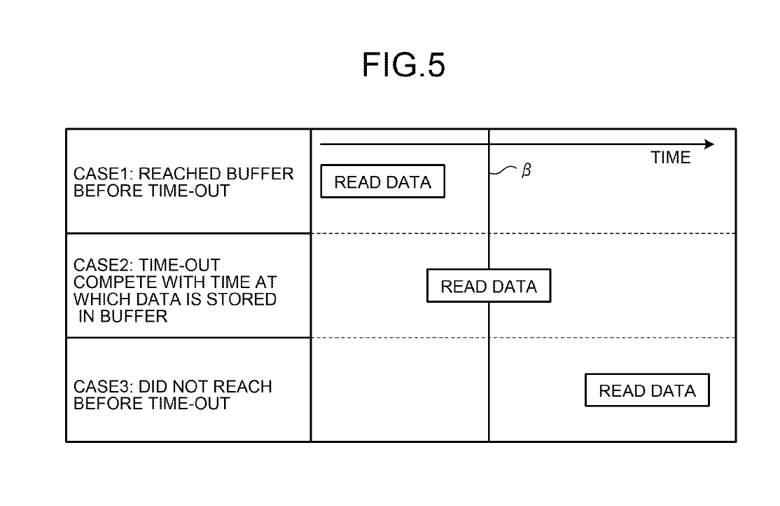

In the following, the significance of the response management unit 19 includes two buffers, i.e., the avoidance buffer 21 and the normal-use buffer 22, will be described with reference to FIG. 5. FIG. 5 is a schematic diagram illustrating a process for transmitting data performed by a Bus IF that includes a single buffer. The symbol β illustrated in FIG. 5 indicates the time at which a predetermined time period has elapsed after a read request was received, i.e., the time at which a data transmission process is started.

For example, as illustrated by Case 1 in FIG. 5, a Bus IF that includes only one buffer stores data in the buffer before the Bus IF starts the data transmission process and sends the data stored in the buffer. In such a case, because the time at which the data is stored in the buffer does not overlap with the time at which the data stored in the buffer is sent, the Bus IF can send the correct data.

Furthermore, as illustrated by Case 3 in FIG. 5, with the Bus IF that includes only one buffer, if data is stored in the buffer after the data stored in the buffer is sent, the Bus IF is not able to send data but is able to send the correct data when a retry is performed.

In contrast, as illustrated by Case 2 in FIG. 5, if the time at which data is stored in the buffer overlaps with the time at which the data transmission process is started, because data written to and read from the single buffer is simultaneously performed, the data to be sent may possibly be destroyed.

To avoid this possibility, a method for not overlapping the time at which data is stored in a buffer with the time at which data is read may also be used. However, if a circuit that calculates the time of writing and reading of data is used, the size of the circuit becomes large, and thus the circuit of the Bus IF becomes complicated.

In contrast, by using two buffers, i.e., the avoidance buffer 21 and the normal-use buffer 22, the Bus IF 10 according to the embodiment avoids an overlap between the time at which data is stored in the buffer and the time at which data is read. Consequently, the size of the circuit can be reduced and the Bus IF 10 can avoid an overlap between the time at which data is stored in the buffer and the time at which data is read without making the circuit in the Bus IF 10 complicated.

A description will be given here by referring back to FIG. 2. The router 23 receives read requests from the Bus IF 10 and the CPUs 40 to 43. Then, the router 23 acquires, from the register group 25, data that is targeted by the received read request and sends the acquired information to the transmission source of the read request.

Specifically, the router 23 receives, as a read request from each of the Bus IF 10 and the CPUs 40 to 43, a memory address targeted by the read request and a read command indicated that data is to be read. Furthermore, the router 23 selects, by using the arbiter 24, a read request to be executed from among the read requests received from the Bus IF 10 and the CPUs 40 to 43.

Then, the router 23 reads, from the register group 25, the data stored in the memory address targeted by the selected read request and sends the read data to the transmission source of the selected read request.

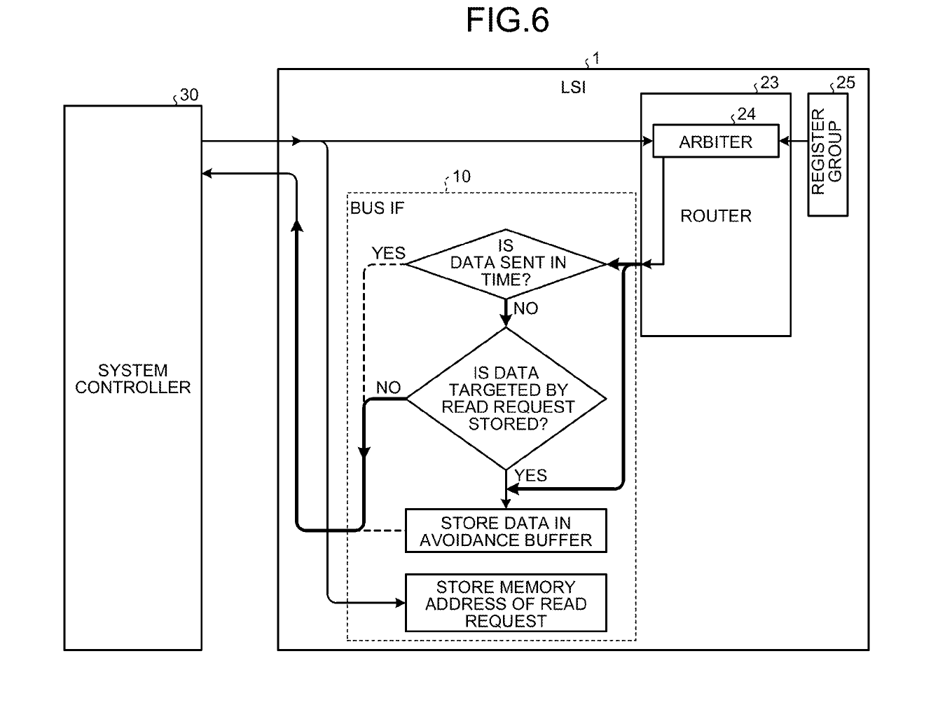

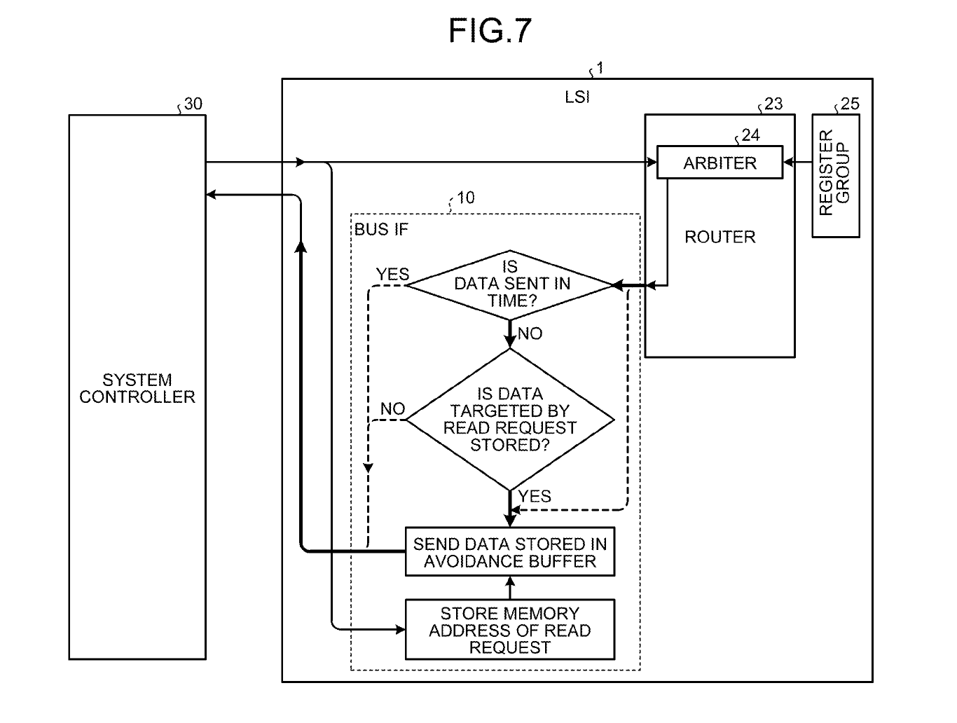

In the following, the flow of a process performed by the LSI 1 for sending data to the system controller 30 will be described with reference to FIGS. 6 and 7. FIG. 6 is a schematic diagram illustrating the flow of a process performed by the LSI for transmitting data in response to a read request. FIG. 7 is a schematic diagram illustrating the flow of a process performed by the LSI for transmitting data in response to a retry.

In the example illustrated in FIG. 6, the system controller 30 sends a read request to the LSI 1. In such a case, the LSI 1 delivers the read request to the router 23 and stores therein a memory address targeted, for a process, by the received read request. If the arbiter 24 selects the read request sent by the system controller 30, the router 23 executes the selected read request and acquires data from the register group 25. Then, the router 23 sends the acquired data to the Bus IF 10.

As represented by the thick line in FIG. 6, the Bus IF 10 determines whether data transmission has been performed within a predetermined time period after the Bus IF 10 received a read request. In the example represented by the thick line in FIG. 6, the Bus IF 10 determines that the data had not been transmitted within the predetermined time period, checks the lock flag in the avoidance buffer 21, and determines whether the data targeted by the read request is stored in the avoidance buffer 21.

Then, the Bus IF 10 determines that the data is not stored in the avoidance buffer 21 and notifies the system controller 30 that the reading of the data has failed. Furthermore, the Bus IF 10 stores, in the avoidance buffer 21, the data acquired from the router 23 after a predetermined time period has elapsed.

As illustrated in FIG. 7, if the system controller 30 receives, from the LSI 1, a notification indicating that the reading has failed, the system controller 30 re-sends the read request that was immediately previously sent to the LSI 1. Then, the LSI 1 delivers the received read request to the router 23 again and allows the data to be acquired from the register group 25. At this point, the LSI 1 determines whether the data has been re-sent within a predetermined time period.

In the example illustrated by the thick line in FIG. 7, the Bus IF 10 determines that the data has not been re-sent within a predetermined time period and then checks whether the data targeted by the read request is stored in the avoidance buffer 21. Then, as illustrated by the thick line in FIG. 6, because the data targeted by the read request is stored in the avoidance buffer 21, the Bus IF 10 sends the data stored in the avoidance buffer 21 to the system controller 30, as illustrated by the thick line in FIG. 7.

As described above, if the Bus IF 10 according to the first embodiment does not receive data targeted by a read request within a predetermined time period after it has received the read request, the Bus IF 10 stores the data in the avoidance buffer 21. Then, if the Bus IF 10 receives a retry of a read request for the data that is stored in the same memory address and if the Bus IF 10 does not acquire data again within a predetermined time period after the Bus IF 10 has received the read request, the Bus IF 10 sends the data stored in the avoidance buffer 21.

Consequently, the LSI 1 that includes the Bus IF 10 reliably responds to the retry, within two retries, of the read request for data whose transmission has failed. Consequently, even if competition occurs in the LSI 1, the LSI 1 can respond to the read request without entering a live lock.

Strictly speaking, a temporal error is present between the data that is sent when data transmission with respect to a retry fails twice, i.e., the data stored in the avoidance buffer 21, and the data requested from the system controller 30 to be read.

However, because the clock speed of the bus that connects the system controller 30 and the LSI 1 is slower than that of the internal clock of the LSI 1, in general, an operation in which it is assumed that data is not able to be acquired at a precise time is used for the system controller 30. Consequently, the data with respect to a retry and the data stored in the avoidance buffer 21 are regarded as the same and thus there is no problem with sending the data stored in the avoidance buffer 21 to the system controller 30.

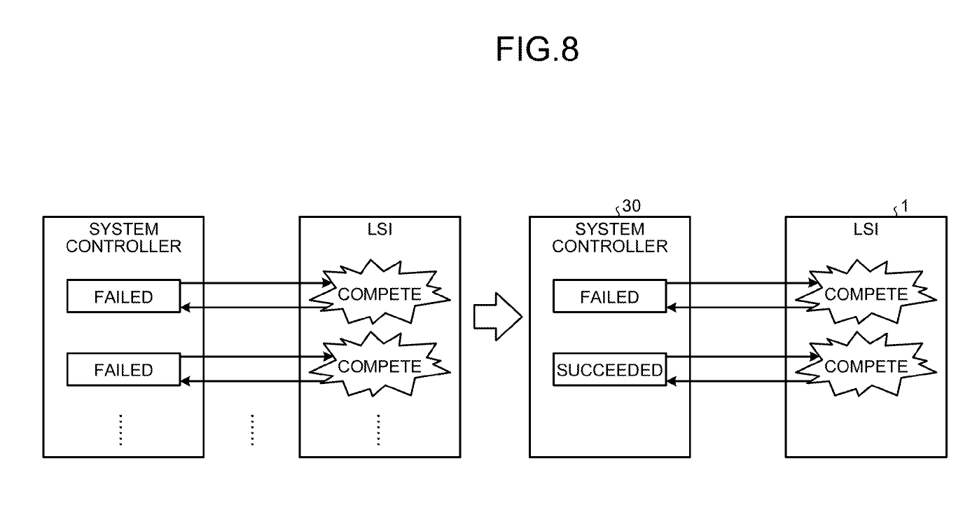

FIG. 8 is a schematic diagram comparing a conventional LSI with the LSI according to the first embodiment. As illustrated on the left side of FIG. 8, with a conventional LSI, because read requests compete with each other in an LSI, a system controller is repeatedly notified of a failure of the reading, which may possibly result in a live lock. However, as illustrated in the right side of FIG. 8, because the LSI 1 can reliably respond to a retry, the LSI 1 can prevent a live lock.

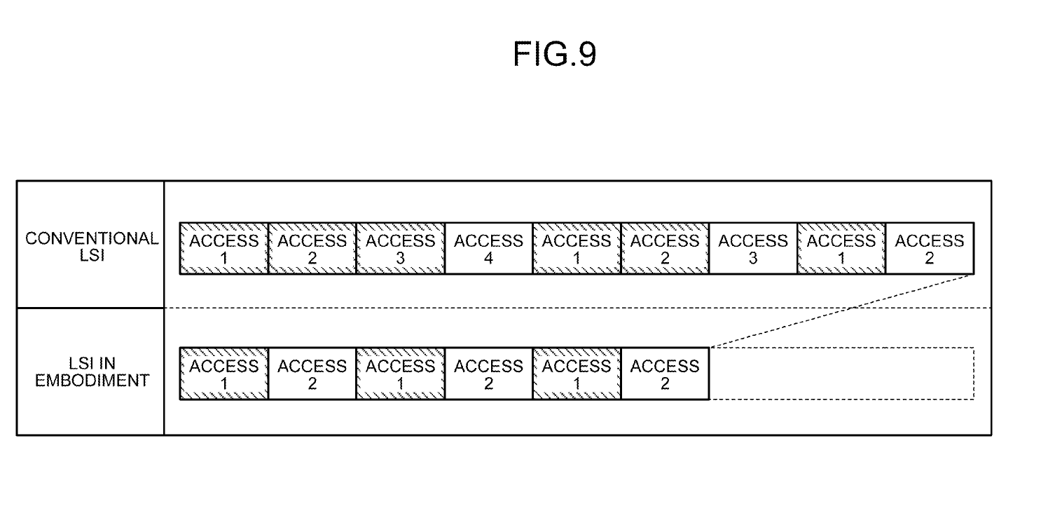

Furthermore, because the LSI 1 can reliably respond to a retry, the LSI 1 can improve the effectiveness of the bus that connects the system controller 30 and the LSI 1. FIG. 9 is a schematic diagram illustrating the utilization rate of a bus. The example in FIG. 9 illustrates the time occupied by a bus until read requests for three pieces of data have succeeded. The accesses illustrated by the oblique lines in FIG. 9 indicates accesses in which a read request has failed and the accesses illustrated without the oblique lines indicates accesses in which a read request has succeeded.

In the example illustrated in FIG. 9, because the conventional LSI is not able to reliably respond to a retry, a retry is performed three times until a read request for the first data has succeeded and a retry is performed twice until a read request for the second data has succeeded. In contrast, because the LSI 1 can reliably respond to a retry, the time used by the bus until a read request for three pieces of data has succeeded becomes short. Consequently, the LSI 1 can improve the effectiveness of the bus.

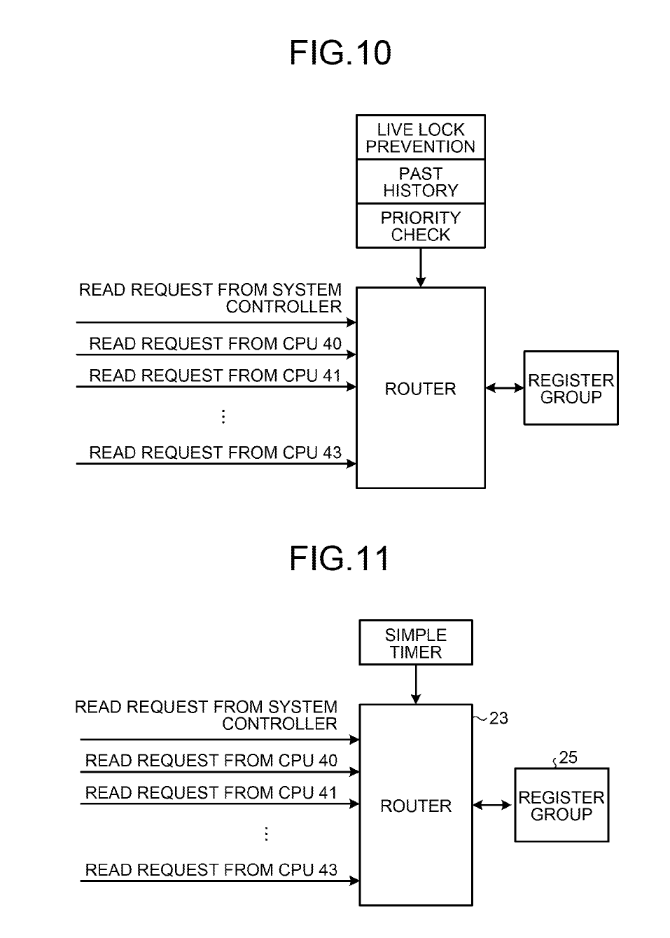

Furthermore, the LSI 1 reliably responds to a retry without giving a priority to a read request. This can simplify the circuit in the router 23, thus reducing the size of the circuit. FIG. 10 is a schematic diagram illustrating a router that processes a read request to which a priority has been given. As illustrated in FIG. 10, a conventional router includes a circuit that checks the priority given to a read request from each of the system controller 30 and the CPUs 40 to 43, a circuit that checks the history of a read request that was executed in the past, a circuit that prevents a live lock, and the like. Consequently, with the conventional LSI, there is a problem in that the size of a circuit becomes large and the circuit becomes complicated.

In contrast, as illustrated in FIG. 11, the router 23 only includes a simple timer that is used to select, in a round robin manner, a read request to be executed from among the read requests received from the system controller 30 and the CPUs 40 to 43. Consequently, when compared with the conventional LSI, the LSI 1 is implemented with a simple and compact circuit. FIG. 11 is a schematic diagram illustrating a router according to the first embodiment.

The state management circuit 16, the time-out monitoring circuit 17, the avoidance control circuit 18, the response circuit 20, the router 23, and the arbiter 24 are, for example, electronic circuits. Examples of the electronic circuits include an integrated circuit, such as an application specific integrated circuit (ASIC) or a field programmable gate array (FPGA), a central processing unit (CPU), or a micro processing unit (MPU).

Furthermore, the address buffer 12, the command buffer 13, and the register group 25 are semiconductor memory devices, such as a random access memory (RAM), a read only memory (ROM), and a flash memory.

Process Performed by the LSI

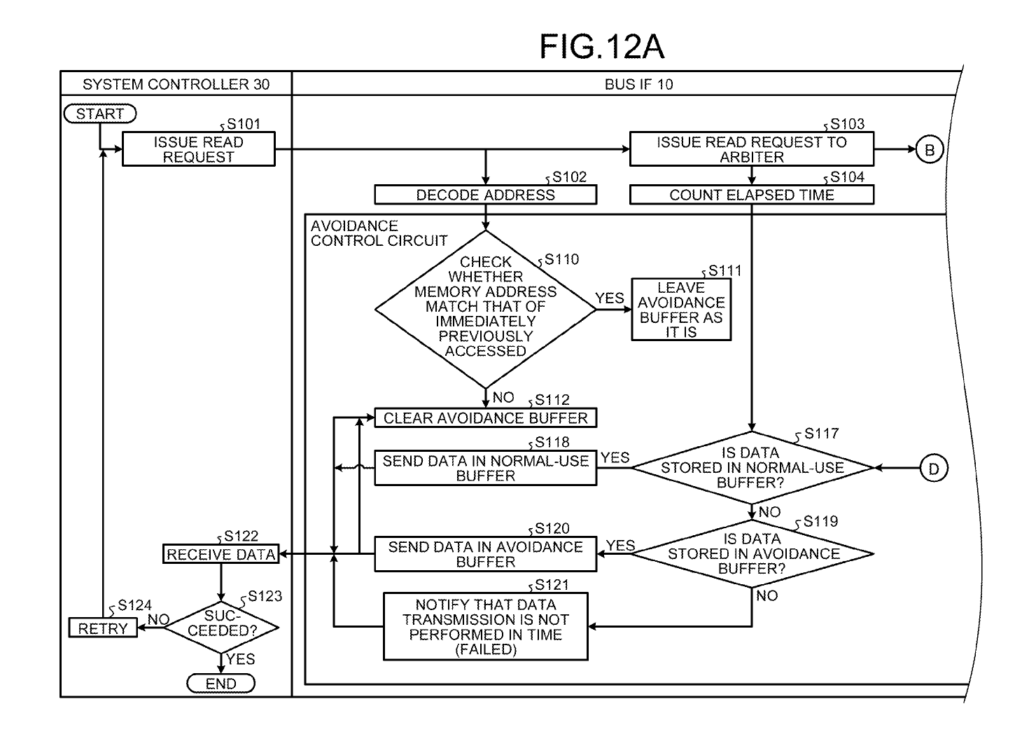

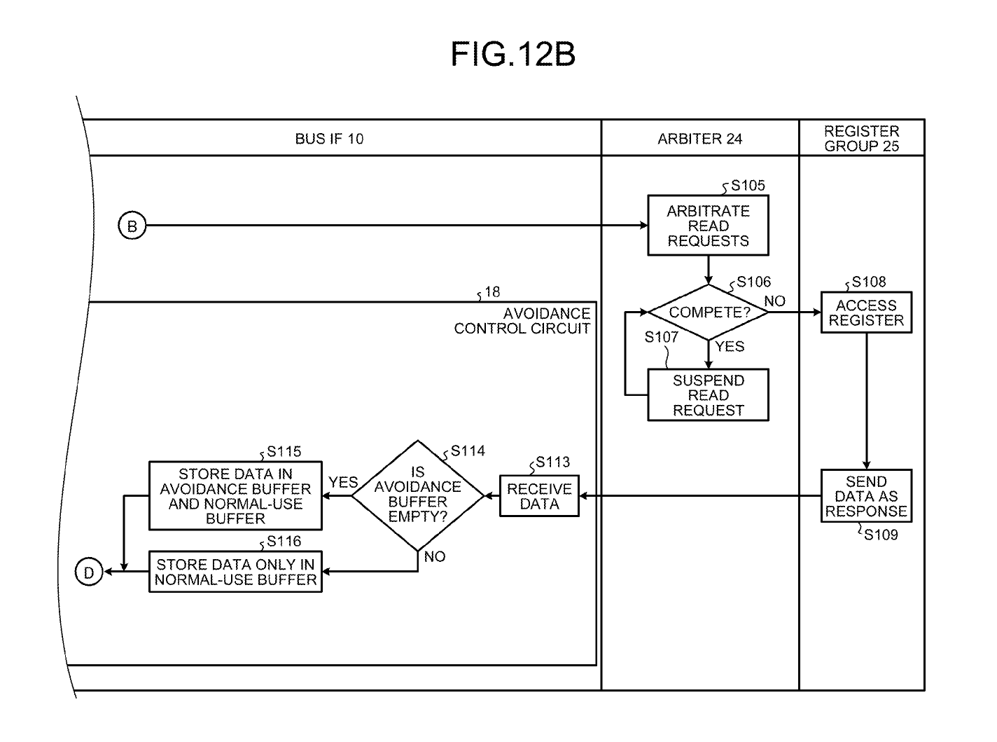

In the following, the flow of a process performed by the LSI 1 will be described with reference to FIGS. 12A and 12B. FIGS. 12A and 12B are flowcharts illustrating the flow of a process performed by the LSI 1. In the example illustrated in FIGS. 12A and 12B, the system controller 30 starts the process triggered when a process for reading data stored in the register group 25 occurs.

First, the system controller 30 issues a read request to the LSI 1 (Step S101). If the Bus IF 10 receives the read request, the Bus IF 10 decodes the memory address targeted by the read request (Step S102). Furthermore, the Bus IF 10 issues a read request to the arbiter 24 in the router 23 (Step S103). Furthermore, the Bus IF 10 counts the time that has elapsed after the Bus IF 10 received the read request (Step S104).

The arbiter 24 arbitrates read requests by using round robin scheduling (Step S105). At this point, the arbiter 24 determines whether competition has occurred (Step S106). If it is determined that competition has occurred (Yes at Step S106), the arbiter 24 suspends the read request received from the system controller 30 (Step S107).

In contrast, if it is determined that competition has not occurred (No at Step S106), the arbiter 24 accesses the register group 25 (Step S108). Then, the register group 25 sends data to the Bus IF 10 as a response (Step S109).

At this point, the avoidance control circuit 18 in the Bus IF 10 determines whether the memory address decoded at Step S102 matches the memory address targeted by the immediately previous read request (Step S110). If it is determined that the memory address decoded at Step S102 matches the memory address targeted by the immediately previous read request (Yes at Step S110), the avoidance control circuit 18 leaves the avoidance buffer 21 as it is (Step S111). In contrast, if it is determined that the memory address decoded at Step S102 does not match the memory address targeted by the immediately previous read request (No at Step S110), the avoidance control circuit 18 clears the data stored in the avoidance buffer 21 (Step S112).

Furthermore, if the response management unit 19 receives data (Step S113), the avoidance control circuit 18 determines whether the avoidance buffer 21 is empty (Step S114). If it is determined that the avoidance buffer 21 is empty (Yes at Step S114), the avoidance control circuit 18 stores the data in the avoidance buffer 21 and the normal-use buffer 22 (Step S115).

In contrast, if it is determined that the avoidance buffer 21 is not empty (No at Step S114), the avoidance control circuit 18 stores the data in the normal-use buffer 22 (Step S116). Then, if a predetermined time period has elapsed after a read request is received, the avoidance control circuit 18 starts a data transmission process and then determines whether data is stored in the normal-use buffer 22 (Step S117).

If it is determined that data is stored in the normal-use buffer 22 (Yes at Step S117), the avoidance control circuit 18 sends the data stored in the normal-use buffer 22 to the system controller 30 (Step S118). Furthermore, if the avoidance control circuit 18 sends the data stored in the normal-use buffer 22 to the system controller 30, the avoidance control circuit 18 clears the data stored in the avoidance buffer 21 (Step S112).

In contrast, if it is determined that data is not stored in the normal-use buffer 22 (No at Step S117), the avoidance control circuit 18 determines whether data is stored in the avoidance buffer 21 (Step S119). If it is determined that data is stored in the avoidance buffer 21 (Yes at Step S119), the avoidance control circuit 18 sends the data stored in the avoidance buffer to the system controller 30 (Step S120). Furthermore, if the avoidance control circuit 18 sends the data stored in the avoidance buffer 21 to the system controller 30, the avoidance control circuit 18 clears the data stored in the avoidance buffer 21 (Step S112).

In contrast, if it is determined that data is not stored in the avoidance buffer 21 (No at Step S119), the avoidance control circuit 18 notifies the system controller 30 that data transmission has failed (Step S121). Furthermore, if the system controller 30 receives data from the Bus IF 10 (Step S122), the system controller 30 determines whether the read request has succeeded (Step S123).

If the read request has succeeded (Yes at Step S123), the system controller 30 ends the process. In contrast, if the read request has failed (No at Step S123), the system controller 30 issues a retry of the read request (Step S124).

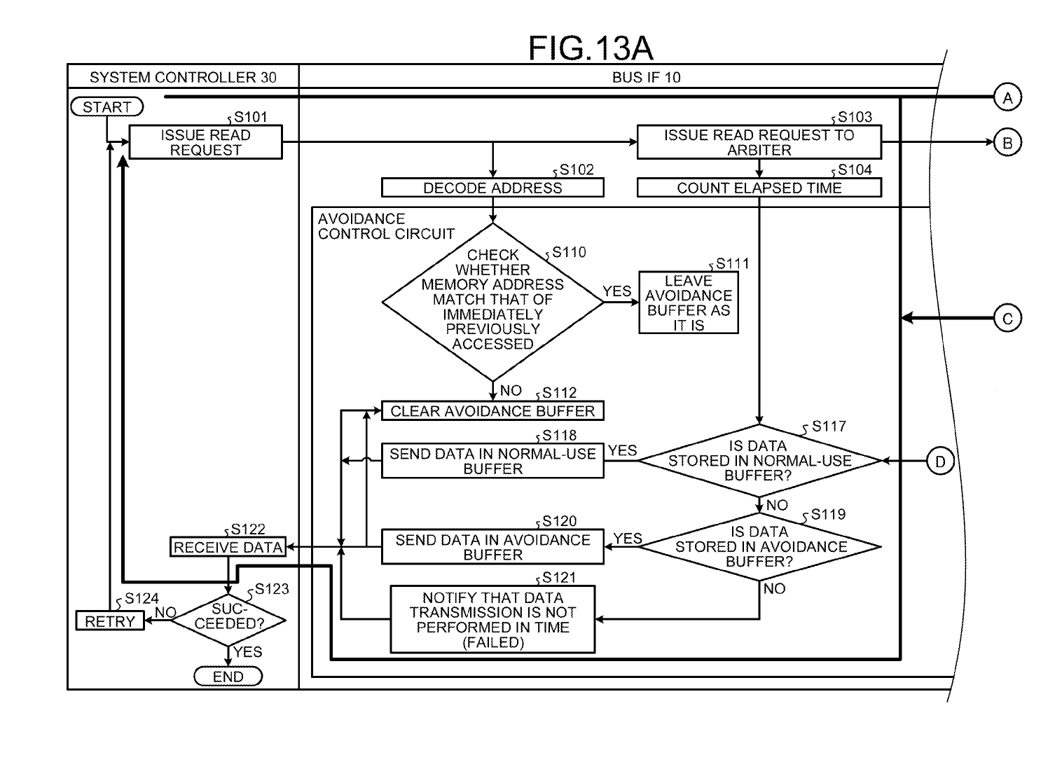

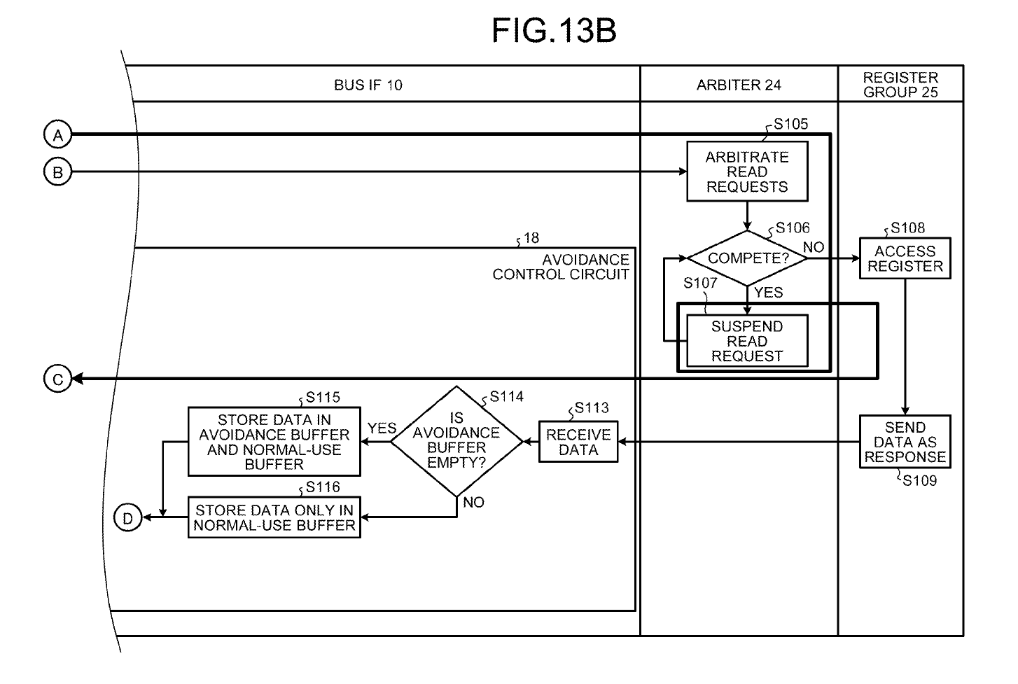

In the following, the flow of a process performed by the Bus IF 10 will be described with reference to FIGS. 13A and 13B. FIGS. 13A and 13B are flowcharts illustrating the flow of a process performed when data transmission has failed. In the example represented by the thick line in FIGS. 13A and 13B, if the system controller 30 issues a read request (Step S101), the Bus IF 10 decodes a memory address (Step S102) and issues a read request to the arbiter 24 (Step S103).

The arbiter 24 arbitrates read requests (Step S105), determines that the read requests are competing with each other (Yes at Step S106), and suspends the read request received from the system controller 30 (Step S107). Then, the arbiter 24 determines that the competition of read requests has been relieved (No at Step S106), accesses the register (Step S108), and sends, to the Bus IF 10, the data received from the register group 25 as a response (Step S109).

If the avoidance control circuit 18 in the Bus IF 10 receives the data (Step S113), the avoidance control circuit 18 determines that the avoidance buffer 21 is empty (Yes at Step S114), the avoidance control circuit 18 stores the data in the avoidance buffer 21 and the normal-use buffer 22 (Step S115). At this point, the avoidance control circuit 18 starts the data transmission process before storing the data and then determines whether data is stored in the normal-use buffer 22 (Step S117).

Furthermore, the avoidance control circuit 18 determines that the data is not stored in the normal-use buffer 22 (No at Step S117) and it then determines whether the data is stored in the avoidance buffer 21 (Step S119). Then, the avoidance control circuit 18 determines that the data is not also stored in the avoidance buffer 21 (No at Step S119) and it then notifies the system controller 30 that data transmission has failed (Step S121).

Then, if the system controller 30 receives a notification that data transmission has failed (No at Step S123), the system controller 30 issues a retry of the read request for the failed data to the Bus IF 10 (Steps S124 and S101).

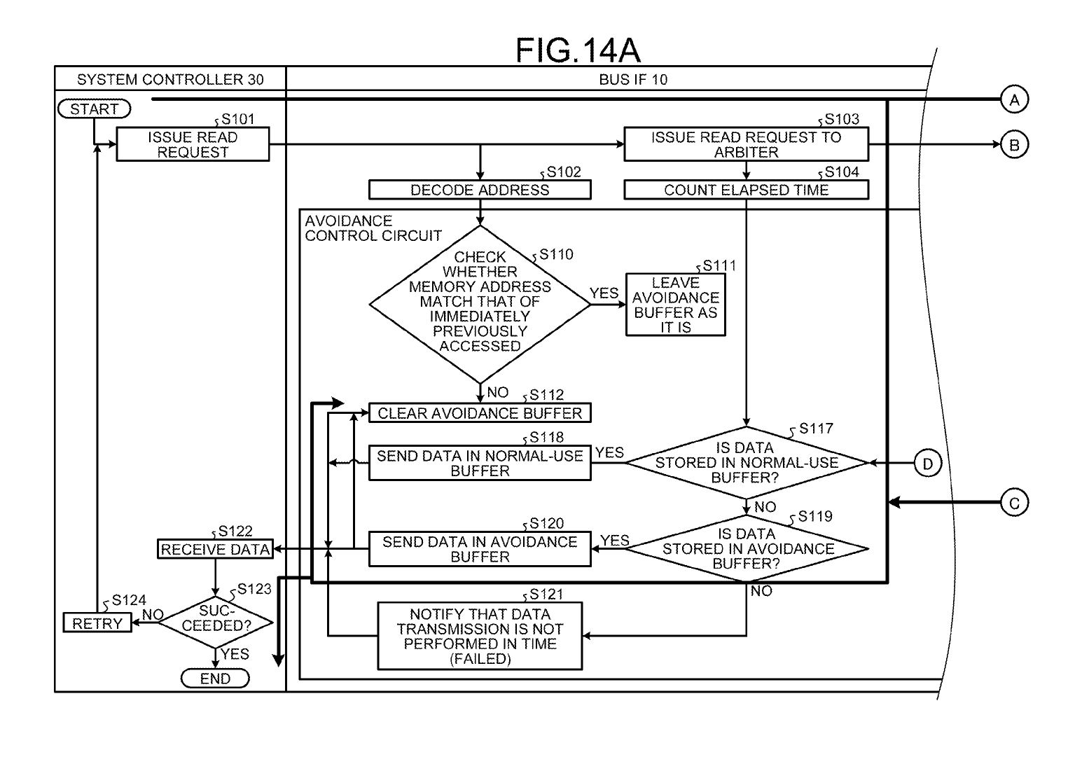

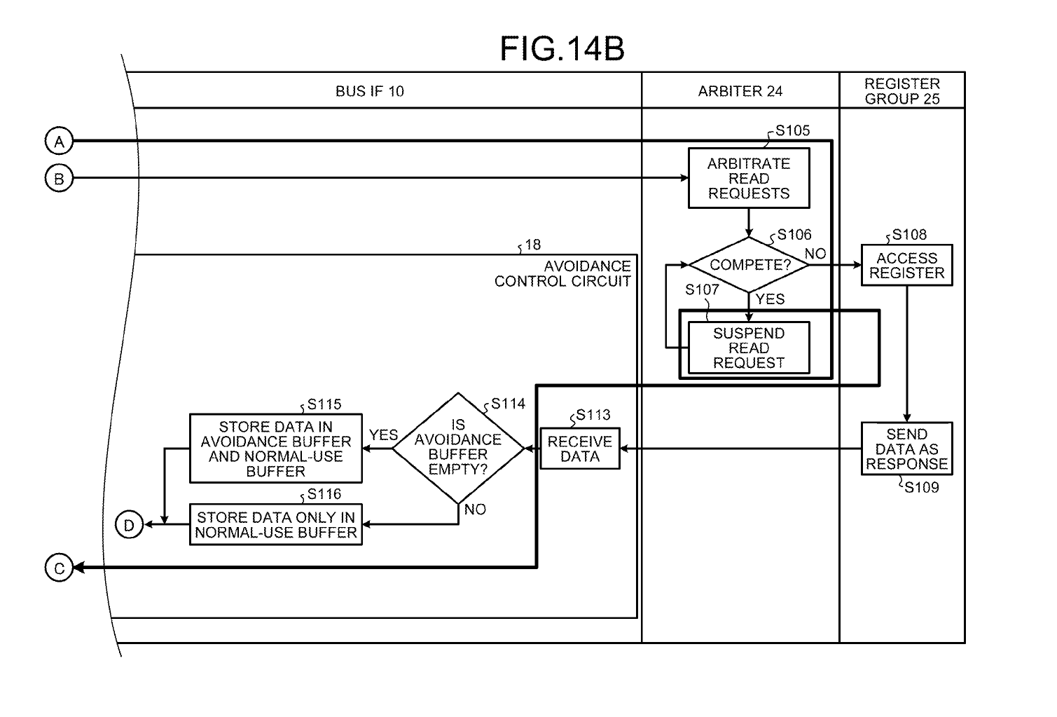

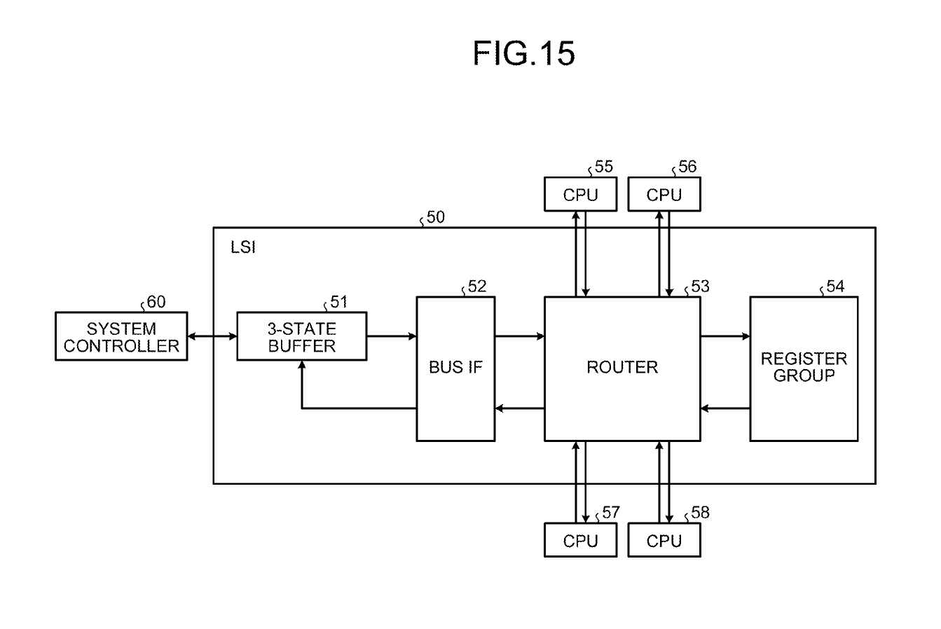

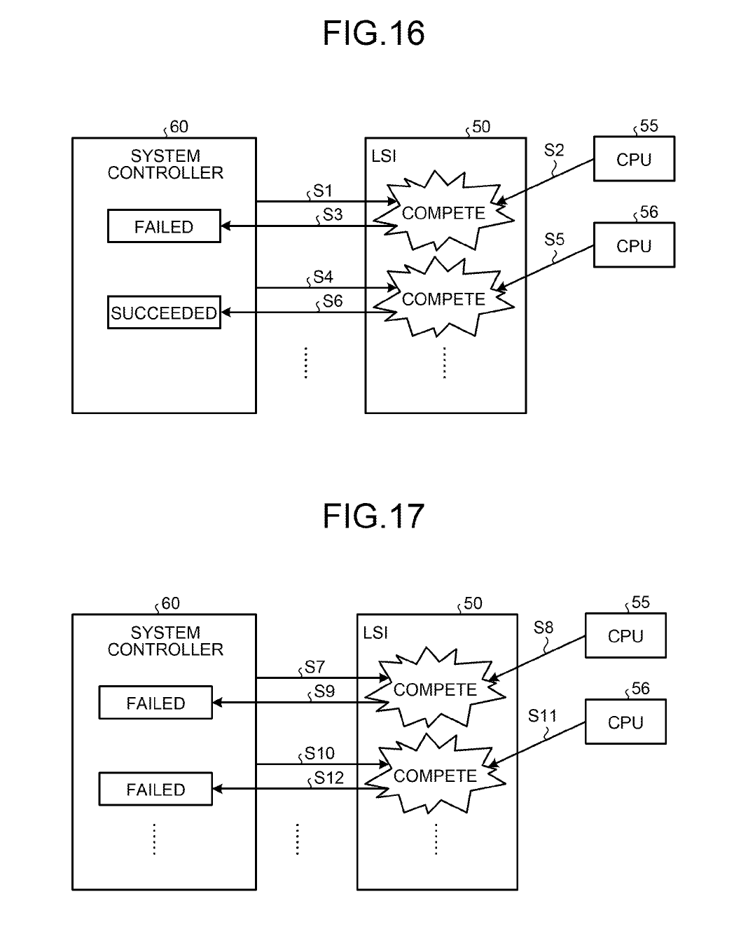

In the following, the flow of a process performed when a retry is performed by the Bus IF 10 will be described with reference to FIGS. 14A and 14B. FIGS. 14A and 14B are flowcharts illustrating the flow of a process performed when a retry is performed. From among the processes represented by the thick line illustrated in FIGS. 14A and 14B, processes at Steps S101 to S118 are the same as those represented by the thick line illustrated in FIGS. 13A and 13B; therefore, descriptions thereof will be omitted.

In the example represented by the thick line illustrated in FIGS. 14A and 14B, the avoidance control circuit 18 that has started the data transmission process determines whether data is stored in the avoidance buffer (Step S119). Then, the avoidance control circuit 18 determines that data is stored in the avoidance buffer 21 (Yes at Step S119) and then it sends the data stored in the avoidance buffer 21 to the system controller 30 (Step S119). If the system controller 30 receives the data stored in the avoidance buffer 21 (Step S122), the system controller 30 determines that data is successfully acquired (Yes at Step S123) and then ends the process.

### Advantage of the First Embodiment

As described above, if the Bus IF 10 is not able to acquire data before a predetermined time period has elapsed after the Bus has IF 10 received a read request, the Bus IF 10 stores, in the avoidance buffer 21, data that is received after the predetermined time period had elapsed. Then, when the Bus IF 10 receives a retry of the read request, if the Bus IF 10 is not able to acquire the data before the predetermined time period has elapsed, the Bus IF 10 sends the data stored in the avoidance buffer 21 to the system controller 30.

Consequently, the Bus IF 10 can reliably respond to the retry of the read request. Thus, the Bus IF 10 improves the utilization of the bus that connects the system controller 30 and the LSI 1 and prevents a live lock occurring due to competition between read requests. Furthermore, because the Bus IF 10 reliably responds to a retry of a read request without giving a priority to the read request, it is possible to simplify the circuit in the router 23 and thus it is possible to reduce the size of the circuit so that it is smaller than that of a conventional circuit.

Furthermore, the Bus IF 10 determines whether a memory address for a process targeted by the most recently received read request matches a memory address for a process targeted by the read request that has been received again. If the Bus IF 10 determines that the memory addresses match, the Bus IF 10 determines that the read request that has been received again is a retry of the most recently received read request.

Furthermore, the Bus IF 10 includes a lock flag that indicates whether data is stored in the avoidance buffer 21. If the Bus IF 10 receives a read request in which a memory address that is different from the memory address indicated by the most recently received read request is to be processed, the Bus IF 10 sets the lock flag to “0”. Specifically, if the received read request is not a retry of the most recently received read request, the Bus IF 10 disables the data stored in the avoidance buffer 21. Consequently, the Bus IF 10 can send appropriate data with respect to the retry.

Furthermore, the bus that connects the system controller 30 and the LSI 1 that includes the Bus IF 10 is a bus that operates at a clock frequency with a speed lower than that used to exchange information between the Bus IF 10 and the register group 25. Consequently, the LSI 1 can, together with multiple LSIs that execute the same process as that executed by the LSI 1, exchange data with the system controller 30 via a single shared bus.

### [b] Second Embodiment

In the first embodiment, the LSI 1 that includes the Bus IF 10 has been described; however, the present invention may also be implemented with various kinds of embodiments other than the embodiment described above. Therefore, in the following, another embodiment included in the present invention will be described as a second embodiment.

(1) Requests Received by the LSI 1

The LSI 1 described above receives a read request from the system controller 30; however, the embodiment is not limited thereto. For example, the LSI 1 receives, from the system controller 30, a read request or a write request that requests the writing of data to the register group 25. Then, the LSI 1 determines whether the command stored in the command buffer 13 indicates reading or writing of data. If it is determined that the received command indicates reading of data, the LSI 1 may also execute each of the processes described in the first embodiment and, if it is determined that the received command indicates writing of data, the LSI 1 may also execute a write process that is executed normally.

(2) Router

The router 23 described above receives not only read requests sent from the system controller 30 but also read requests sent from the CPUs 40 to 43; however, the embodiment is not limited thereto. For example, the router 23 may also receive a read request from, for example, multiple Input/Outputs (I/Os) or another chip set and execute the received read request.

According to an aspect of an embodiment of the present invention, a response is reliably made with respect to a send request that is resent.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information transfer device comprising:
a storing unit that temporarily stores therein information to be sent;
an acquiring unit that acquires, when a send request of information stored in a storage device is received from an information processing apparatus, information requested by the send request from the storage device even after a predetermined time period after the send request was received had elapsed;
a sending unit that sends, when the acquiring unit has acquired the information requested by the send request from the storage device within the predetermined time period after the send request was received, the information acquired by the acquiring unit to the information processing apparatus and that sends, when the acquiring unit has not acquired the information requested by the send request from the storage device within the predetermined time period after the send request was received, a notification indicating that acquiring information was failed to the information processing apparatus; and
a retaining unit that stores the information acquired by the acquiring unit after the predetermined time period has elapsed to the storing unit, wherein
when the acquiring unit receives from the information processing apparatus a re-send request that is a retry of the send request for the information requested by the send request, the acquiring unit acquires the information requested by the re-send request from the storage device, and
when the acquiring unit acquired the information requested by the re-send request from the storage device within the predetermined time period after the re-send request was received, the sending unit sends the information acquired by the acquiring unit to the information processing apparatus, and, when the acquiring unit has not acquired the information requested by the re-send request from the storage device within the predetermined time period after the re-send request was received, the sending unit sends the information stored in the storing unit to the information processing apparatus.

2. The information transfer device according to claim 1, wherein,
when the acquiring unit receives the send request of information from the information processing apparatus, the acquiring unit determines whether a memory address in which the information requested by the send request is stored matches a memory address in which information requested by a send request that was most recently received, and
when the acquiring unit determines that both of the memory addresses are match, the acquiring unit determines that the re-send request for the information requested by the send request that was most recently received is received.

3. The information transfer device according to claim 1, wherein
the storing unit has flag information that indicates whether information is stored in the storing unit,
when the retaining unit stores, in the storing unit, the information acquired by the acquiring unit after the predetermined time period has elapsed, the retaining unit sets the flag information indicating that the information is stored in the storing unit, and
when the acquiring unit has not acquired the information requested by the re-send request from the storage device within the predetermined time period after the re-send request was received, the sending unit checks the flag information stored in the storing unit, and, when the flag information indicates that the information is stored in the storing unit, the sending unit sends the information stored in the storing unit to the information processing apparatus.

4. The information transfer device according to claim 3, wherein, when the acquiring unit acquired the information requested by the re-send request from the storage device within the predetermined time period after the re-send request was received, the sending unit sends the information acquired by the acquiring unit to the information processing apparatus and sets flag information indicating that the information is not stored in the storing unit.

5. The information transfer device according to claim 3, wherein the sending unit is connected to the information processing apparatus by a bus that sends and receives information at a transmission speed lower than transmission speed between the acquiring unit and the storage device.

6. An information transfer method performed by an information transfer device that transfers information, the information transfer method comprising:
acquiring, when a send request of information stored in a storage device is received from an information processing apparatus, the information requested by the send request from the storage device even after a predetermined time period after the send request was received had elapsed;
sending, when the information requested by the send request was acquired at the acquiring from the storage device within the predetermined time period after the send request was received, the information acquired at the acquiring to the information processing apparatus, and sending, when the information requested by the send request was not acquired at the acquiring from the storage device within the predetermined time period after the send request was received, a notification indicating that acquiring information was failed to the information processing apparatus; and
retaining the information acquired at the acquiring after the predetermined time period has elapsed in a temporary storage device that temporarily stores therein information, wherein
acquiring includes acquiring, when a re-send request that is a retry of the send request for the information requested by the send request is received from the information processing apparatus, the information requested by the re-send request from the storage device, and
the sending includes sending, when the information requested by the re-send request was acquired at the acquiring from the storage device within the predetermined time period after the re-send request was received, the information acquired at the acquiring to the information processing apparatus, and sending, when the information requested by the re-send request was not acquired at the acquiring from the storage device within the predetermined time period after the re-send request was received, the information retained at the retaining in the temporary storage device to the information processing apparatus.
